(19) United States
(12) Patent Application Publication
(10) Pub. No.: US 2021/0337986 A1
(43) Pub. Date: Nov. 4, 2021

(54) A STORAGE SYSTEM WITH A NUMBER OF LATERALLY DISPLACEABLE STORAGE RACKS

(71) Applicant: Espen WATHNE, Mandal (NO)

(72) Inventor: Espen WATHNE, Mandal (NO)

(21) Appl. No.: 17/269,952

(22) PCT Filed: Sep. 27, 2019
(86) PCT No.: PCT/NO2019/050199

§ 371 Date: Feb. 19, 2021

(30) Foreign Application Priority Data
Aug. 21, 2018 (NO) 20181099

(51) Int. Cl. A47F 5/10; A47F 7/04; B65G 1/10

(52) U.S. Cl. CPC A47F 5/108; B65G 1/10; A47F 7/04

(57) ABSTRACT

It is described a storage system with a number of laterally displaceable storage racks, the system is comprising:
a plurality of rails (4) mounted on a floor,
a plurality of support frames (1) aligned in succession on the rails (4), each support frame (1) being rectangular with at least two supporting elements (7) parallel to the rails (4), each having a first end and a second end, and at least two coupling members (8) extending across the rails (4), each supporting member (1) comprising wheels (3) with guide flanges (22) abutting the rails;
a rack (2) mounted on each support frame (1),
a drive unit (5) adapted to displace the support frames (1) with racks (2) along the rails (4).

Each support frame (1) has a rotatable locking hook (6) at each support member (7), at the first end of the support member (7), and a corresponding locking lug (13) at the other end, the locking hooks (6) are connected to a rod (12) so that they can be rotated together, and wherein the drive unit (5) is a linear drive unit which is fastened to the floor at a first end, and the other end is coupled to a free support frame (1) in the succession of support frames.

### FIELD OF THE INVENTION

The present invention relates to a system for storing objects.

### BACKGROUND

Storage systems exist in a number of variants. For storing smaller objects, such as books, there exists a compact rack system where mobile racks rolls on rails in the floor (Compactus system). The racks can be pushed close together, with only one opening where material can be inserted. The racks can be displaced along the rails by turning a steering wheel, or by operating an electric motor, so that all racks become available as desired. Such solutions are also applied in other industries, such as for storing tires or car parts. Since there is only a single “space” between the racks, such a system provides a greater storage density than fixed freestanding racks, and therefore better utilization of the premises. Due to the rails, the system depends on an accurate flat and levelled floor. This is not always the case, for example in an external warehouse. Furthermore, the system is exposed to dust and particles falling into the rails/grooves so that the movement of the racks becomes slow or jammed.

Large displaceable rack systems are known in which each rack is equipped with a frame-shaped base. In each base there is an electric motor that moves the rack when required. In order to ensure safety, light fixtures are installed between each rack. This is a costly solution since each rack is fully equipped with a drive system and electronic control system. Furthermore, the base builds a lot, i.e. it requires a relatively large proportion of the height in rooms with limited headroom.

Thus, there is demand for a storage system which is also suitable for storing large and heavy objects, which is modular so that it can be expanded in order to meet the requirements and available space, and which is durable and can be installed in buildings with uneven floor.

Various patented storage solutions are known from prior art, such as described in U.S. Pat. No. 3,080,204 A, JP H01176709 A, U.S. Pat. No. 6,669,314 B1, JP 557104932 U, and U.S. Pat. No. 3,877,593 A.

### SUMMARY OF THE INVENTION

It is an object of the invention to provide a storage system which satisfies at least some of the above-mentioned requirements.

This is achieved with a storage system as defined in the appended claims.

The invention thus comprises a storage system having a plurality of laterally displaceable storage racks, the system comprising:

a plurality of rails attached to a floor, a plurality of supporting frames arranged in succession on the rails, each support frame being rectangular with at least two supporting elements parallel to the rails, each having a first end and a second end, and at least two coupling elements extending across the rails, each supporting member comprising wheels abutting the rails, a rack mounted on each support frame, and a drive unit adapted to displace the support frames with racks along the rails.

Each support member has a rotatable locking hook at the first end of the support member, and a corresponding locking lug at the other end, the locking hooks of the various support members constituting a support frame being connected to a bracket so that they can be rotated together, and the drive unit being a linear drive unit which is attached to the floor at a first end and the other end is connected to a first support frame in the series of support frames.

With such a system, separate drives, control electronics and safety measures are not required in each rack module. This reduces cost. The locking hooks will automatically lock the racks to one another, and the safety is attended to the fact that when the user has fetched an object and leaves an “open” rack, he resets the rack so that the “gap” is closed. In prior art systems there will always be an open “gap”.

The support members are preferably consisting of hollow profiles, each having at least two wheels mounted within each hollow profile, each wheel protruding through an opening in the hollow profile and abutting against a rail, and the supporting frames are further comprising a number of coupling elements connecting the support elements.

This means that the racks can be easily extended in length and width. The structure itself, i.e. the support element, is used as a rack, which allows more space and low building height. The supporting elements can be expanded with extra elements, in order to increase the size so that they can take double pallet racks, or to increase the number of wheels or the size of each wheel to increase the carrying capacity.

According to one embodiment, each support element preferably comprising a plurality of couplings extending horizontally from the support element and the coupling elements are in the form of hollow tubes which are threaded onto the mounting pieces and fastened thereto. This feature simplifies the installation of the system.

Each support member preferably comprising a plurality of holes on the upper side for fastening of the racks, the holes comprising threads, wherein in each hole a threaded mounting sleeve suitable for receiving hollow wall tubes is fitted, with the wall tubes being attached to the mounting housings.

This is also a feature that simplifies the installation of the system. Each wall element in each rack can be assembled in advance and delivered at the construction site, and then mounted separately and raised without support until the racks are mounted. This embodiment may further comprise locking nuts which lock the mounting bush to the support member. This reinforces the construction and is applicable when using tall racks.

According to one embodiment, each support frame may comprise four coupling elements, each support frame being adapted to carry two rows of car tires. Tires can thus also be stored on the support frame at the base of the rack, both in lying and standing position.

According to another embodiment, a pallet rack may be attached to the coupling elements. The rails included in the storage system are preferably in the form of flat steel lying on the floor and attached thereto.

With this construction, you do not have to slit concrete and sink the rails into the floor. The rail will follow the floor, while the rack is flexible enough to also follow the floor. Because the rail is flat and wide, this makes it is easy to run over with a forklift or trolley. The rails can easily be replaced when they are worn out.

The drive unit which is part of the storage system is preferably a pneumatic cylinder, a hydraulic cylinder or an electric linear motor, which is either controlled by remote control or a joystick.

### BRIEF DESCRIPTION OF THE DRAWINGS

The invention will now be described in detail with reference to the accompanying drawings, in which:

FIGS. 1a-c shows an embodiment of a storage system according to the invention, viewed from the side, from the front, and in perspective,

FIG. 2a, b shows an embodiment of the storage system, intended for storing car tires,

FIGS. 3a-d shows the base frame of the storage system,

FIGS. 4a, b shows the hook system used to lock the racks together,

FIGS. 5 and 6 shows how the base frame is constructed,

FIG. 7 shows a tube holder contained in each rack,

FIG. 8 shows the control system for the storage system,

FIG. 9 shows a rack unit which can be used in the storage system, and

FIGS. 10a, b shows a tire basket which can be used to fetch and insert tires into the storage system.

### DETAILED DESCRIPTION OF THE INVENTION

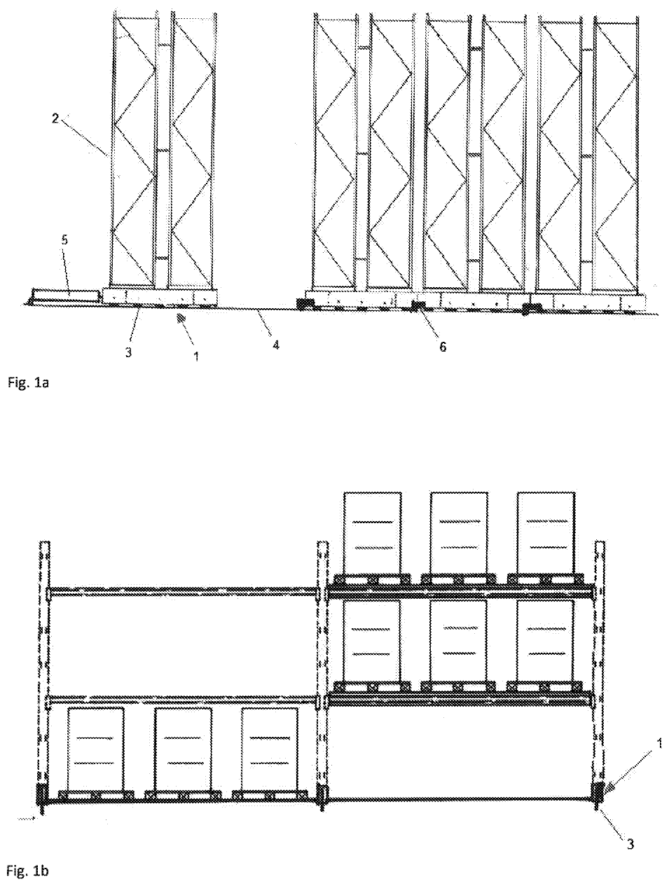

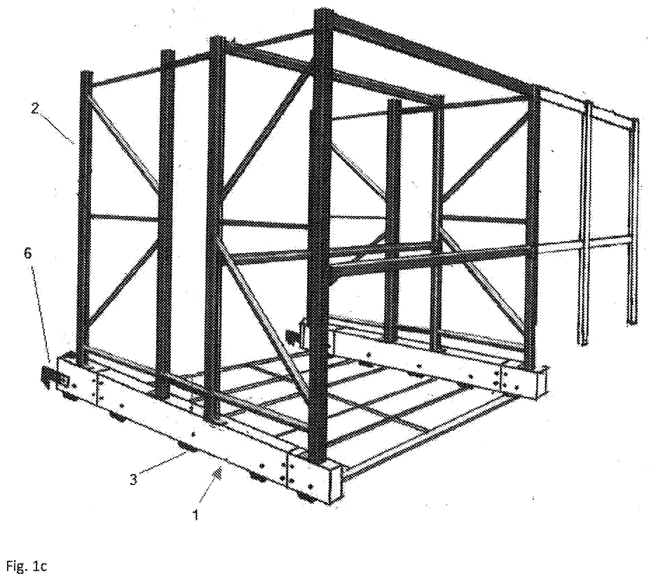

FIGS. 1a-c shows an embodiment of a storage system according to the invention, intended for storage of heavier objects. The system consists of a number of universal base frames 1, each carrying a rack 2, here in the form of a so-called pallet rack. The base frames are equipped with wheels 3 and can roll back and forth along rails 4 in the floor. To drive the base frames with the racks sideways, a drive unit 5 is mounted, here in the form of a pneumatic cylinder with remote control. The base frames are equipped with locking hooks 6 which can interconnect several racks so that they move as a unit. By releasing the locking hooks, the racks can be moved individually.

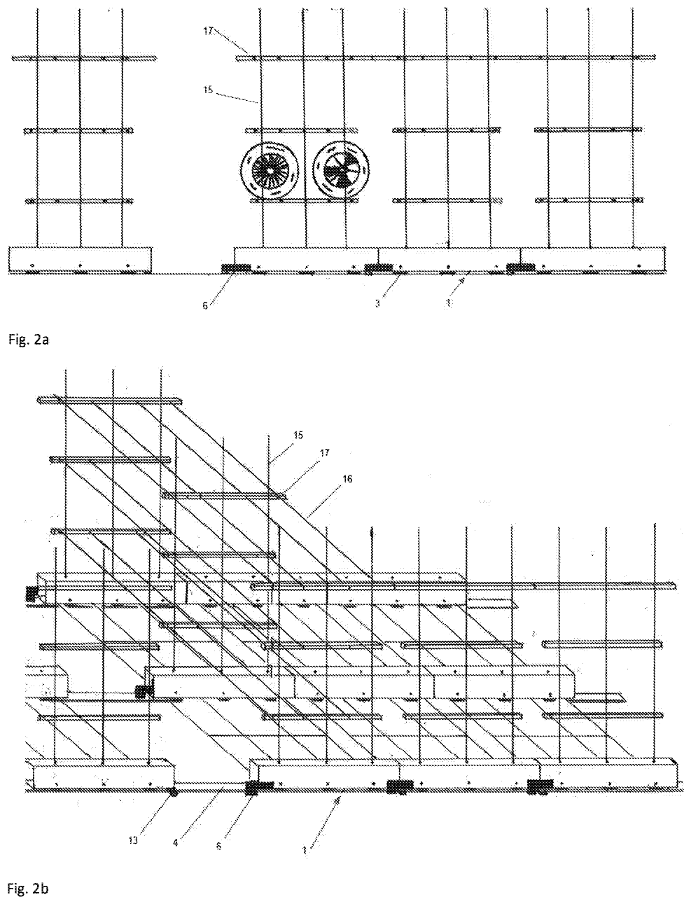

FIGS. 2a, b shows a version of the storage system especially designed for storing car tires. The difference from the previous version lies in the rack system. Each rack 2 here consists of vertical wall tubes 15 and horizontal rack tubes 16 which are joined together by tube holders 17. The tube holders are provided with locking screws locking the tubes. The position of the tubes is therefore adjustable. FIG. 2a shows the system viewed from the side, with two rows of tires placed in one of the racks. Each rack is comprised of four rack tubes 16 and each row of tires rests on two rack tubes. FIG. 2b showing the system in perspective. In this case a base frame with three supporting elements 7 is used.

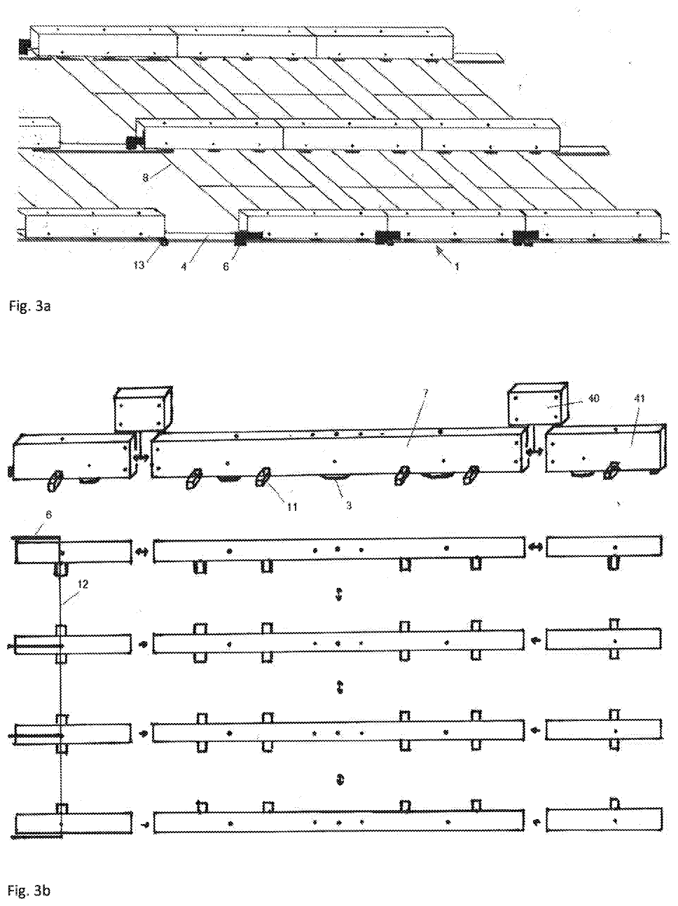

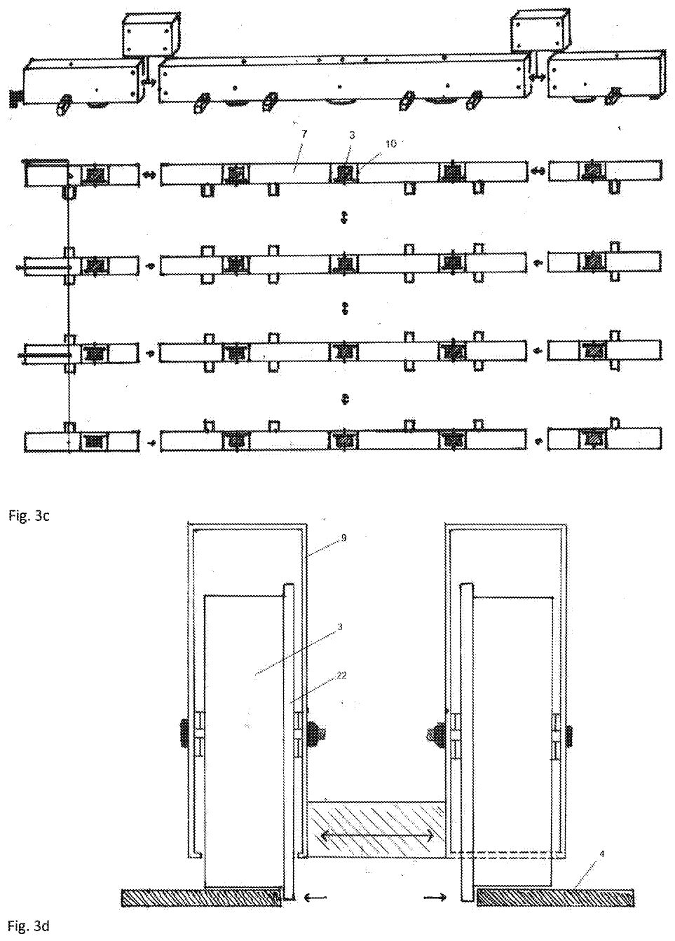

FIGS. 3a-d shows the structure of the base frame 1. The base frame consists of supporting elements 7 held together by coupling elements 8. The supporting elements also form wheel carriers for the racks.

FIG. 3b shows the support elements viewed in perspective (top) and from the top respectively. The supporting elements can be extended by attaching supplementary supporting elements 41. The supplementary supporting elements are provided with wheels and thus can increase the carrying capacity of the base frame they are included in. The object of the supplementary supporting elements may be to adapt the size of the base frame enabling it to be used for double pallet racks. Joints 40 are also shown which can also extend the base frame.

The coupling members may be welded to the support members. Alternatively, the support elements may be provided with short protruding couplings 11 on which the coupling elements, in the form of tubes, are threaded onto and fastened with bolts, screwed on or welded, see also FIG. 5.

FIG. 3c shows in the same way the supporting elements seen from the below. Each support member 7 comprises a plurality of wheels 3 protruding through openings 10 at the base of the support member.

Each support member 7 consists of a square profile 9, i.e. a tube of rectangular cross section, FIG. 3d. Inside the square profile there are mounted wheels 3 which protrude through openings 10 at the base of the support element. FIG. 3a shows three supporting elements 7a-c which are connected together by the coupling elements 8. The number of supporting elements is a dimensioning question. In smaller storage systems, two supports may be enough for each rack, while in larger systems three or more supports may be required. The storage system can be easily expanded in width by adding more supporting elements.

FIG. 3d shows a guide rail 4 in communication with wheels 3. In conventional rack systems, the rails are usually integrated into the floor. This is a costly solution, especially when reusing existing buildings. It can also be a problem when installing a rack system in an older building with uneven floors. In this case, the rail consists of a flat steel mounted on the floor. The rail is secured with expansion bolts through holes in the rail. The wheel 3 has a flange 22 and rolls along the inside of the rail 4. Although the rail should run unevenly due to unevenness in the floor, the rack system will be affected to a small extent and easily pass such unevenness. The support element shown in FIG. 3d comprises a square profile 9. In principle, it is possible to use other types of profiles, for example a U-shaped profile, in proper sizing, but in this case, it is preferred to use a square profile as it is considered to give the right properties of strength to the construction.

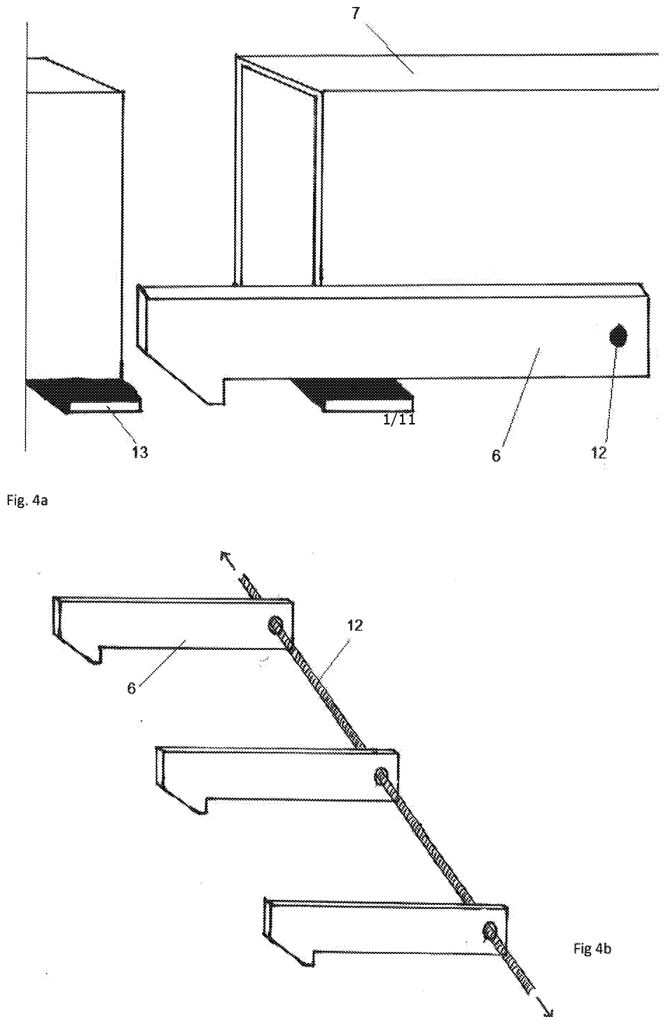

Each support element is also provided with locking hooks 6, FIG. 4a, b, see also FIG. 3b. The locking hooks are coupled to a rod or threaded steel 12 which runs through a coupling element to the opposite side of the rack. All the locking hooks in a row are attached to the same thread steel and can be operated together by turning/lifting on one of the locking hooks on the side of the rack, i.e. the threaded steel forms a rotatable axis for the locking hooks. The locking hooks catch engages locking lugs 13 mounted on the corresponding end of the next rack.

FIG. 5 shows a solution in which coupling elements 8 are assembled into a finished module. Each module can be pre-made and quickly mounted on the support elements when mounting the storage system. The figure also shows how the coupling elements can be fastened to the supporting elements 7. Coupling pieces 11 are here welded to the supporting element 7, i.e. externally of the square profile 9 at the base, and the ends of the coupling elements 8 are inserted into the coupling pieces 11 and bolted.

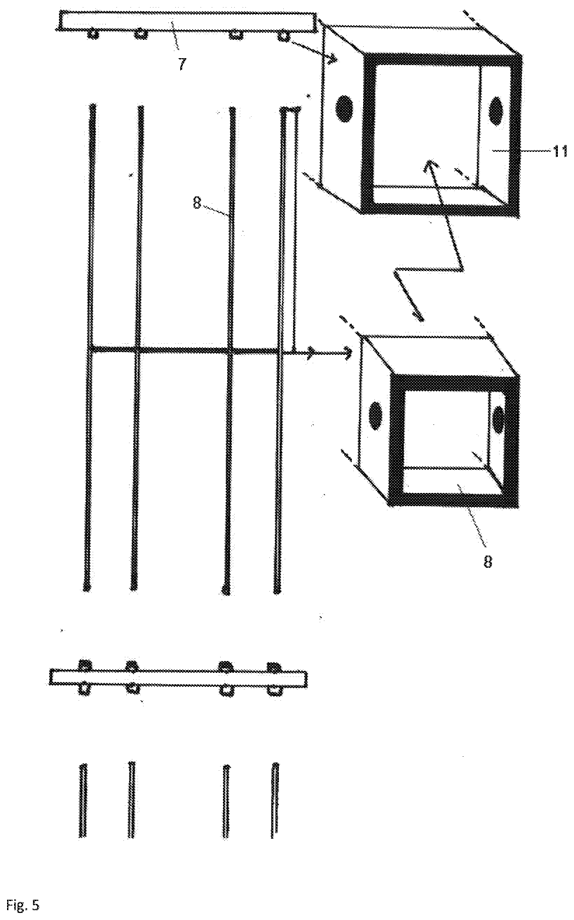

FIG. 6 shows how the wall tubes 15 can be fixed to the supporting elements. Each support element is provided with holes 19 on the upper side. Each hole is threaded to receive and hold a corresponding threaded mounting bush 35. In some cases, it may be desirable to provide the mounting bush with a locking nut on the inside of the square profile. The racks are mounted by placing the wall tubes 15 down on the mounting bushes 35. Pre-finished walls or gables can be made for the racks, consisting of wall tubes and tube holders, which are lifted up and mounted on the supporting elements on site. The solution with mounting nozzles screwed into the support member is preferred over welding them firmly to the support member. The reason for this is that during welding, a bead will be created around the “root” of each mounting bush. This will create an uneven surface for the wall tubes, which in turn can cause bias in the racks. This solution is adapted to tire storage system, as shown in FIG. 2a, b. If the system is to be used for pallet racks or shelving racks, it will be unnecessary to use mounting bushes, as the racks can be bolted directly to the supporting elements.

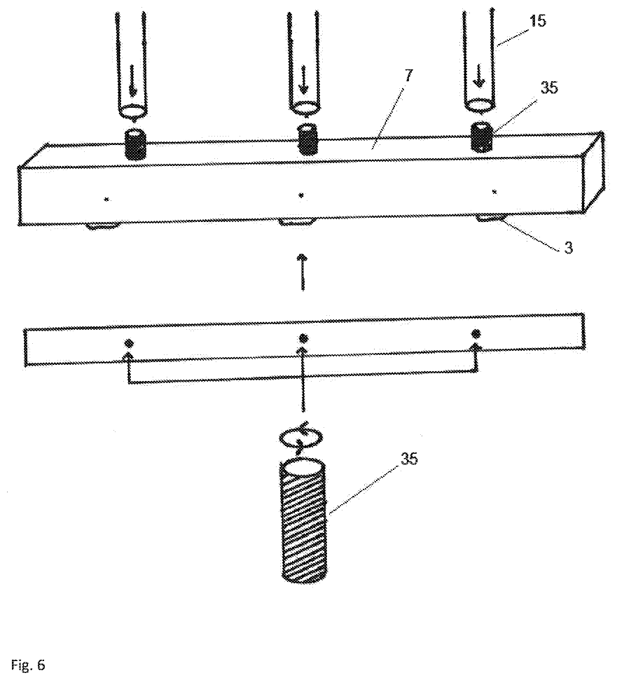

FIG. 7 shows the tube holder used to connect each rack. This is a standard trading component. In this embodiment, it is provided with three vertical through holes 19 for the wall tubes 15 and four horizontal through holes 20 for fixing the rack tubes 16. The tubes are fixed with locking screws 18 mounted at the side of each hole.

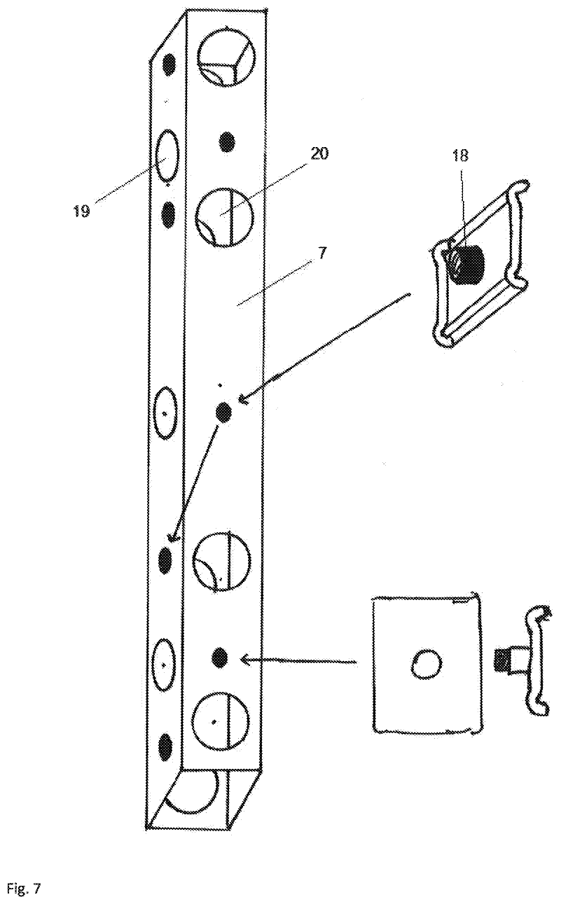

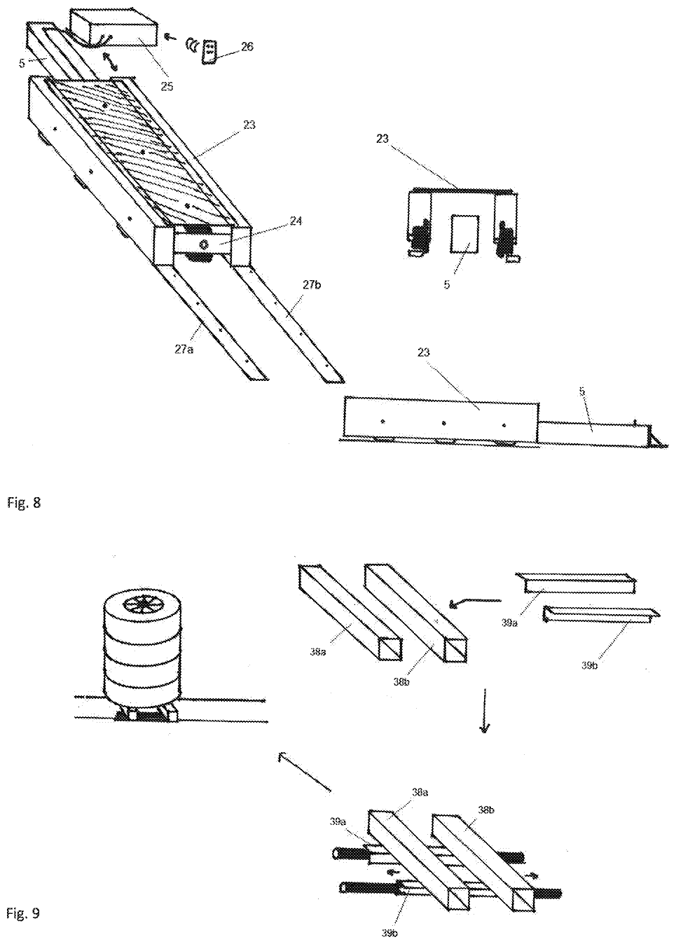

FIG. 8 shows the control system to move the racks back and forth. The system comprises a pneumatic cylinder 5 which is mounted inside a cylinder box 23. The cylinder 5 is fixed to the floor at the rear edge and is forwardly attached to an end wall 24 in the cylinder box 23. The cylinder 5 is connected to a control unit. 25 with valves and control electronics. The control unit 25 is connected to a compressed air line, e.g. from a compressor and operated by a wireless unit 26. Alternatively, the system can be controlled with a joystick, with a wired connection to the control unit. The cylinder box is carried by wheels which roll along two cylinder guide rails 27a, b which are fixed to the floor.

The rack system shown in FIG. 2a, b is specially designed for storing car tires in a tire hotel. The base frame shown comprises four coupling elements and is therefore suitable for carrying two rows of tires. The shelving system can therefore be used all the way down to the floor and builds similarly little in height. However, the system is also useful for storing other products. The support frame can then easily be extended with connected elements 28 in order to accommodate a double set of pallet racks.

FIG. 9 shows an adjustable rack unit designated to be mounted on the rack tubes of a rack. The rack element makes it easy to fetch stored objects with a forklift. The rack element comprises two support tubes 38a, b which are attached to two parallel angel sections 39a, b. The support tubes are preferably square in cross section. Each angel section lies with a flat side against the support tubes and is attached to them, for example by welding or by using bolts. The opposite flat faces of the two flat bars, which are vertical, are preferably mounted so that they face each other, thereby gripping the inside of each rack tube in the rack. Alternatively, the flat irons can be mounted in opposite directions so that they are facing apart. In any case, they will grip the racks and prevent the rack element from falling off the rack. However, the rack member can be displaced sideways along the rack tubes. The rack element is suitable for storing larger objects on the racks, and also where you want to store tires in stacks.

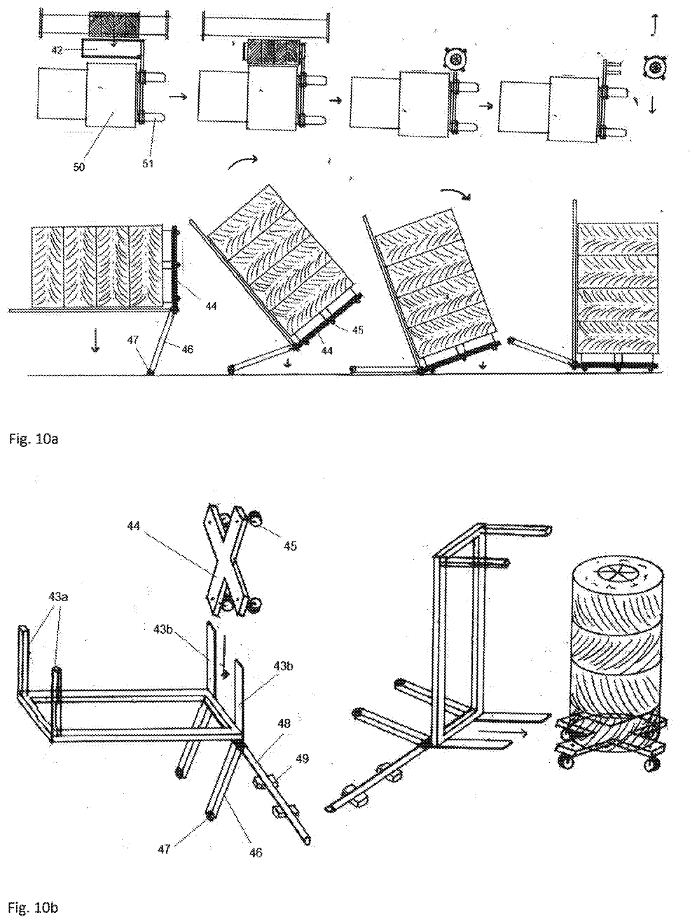

FIGS. 10a, b shows a tire basket 42 specially designed for retrieving and transporting tires in a storage system according to the present invention. The basket comprises a frame with two posts 43a, b at each end. On the basket a tire trolley 44 is inserted, towards the posts at one end. The tire trolley 44 is equipped with wheels 45. To prevent the tire trolley from falling over, it can be mounted on shackles or pins, either in front of the posts 43b or on the trolley (not shown). Furthermore, two support arms 46 are attached to the tire trolley 44, each with a support wheel 47 at the end. The angle between the basket and support arms is adjustable. A swivel shaft 48 is attached to the basket with supporting arms 48. Two fork sleeves 49 are mounted to the arm 48. The pick-up trolley is intended to be mounted on a forklift 50 by pulling the forks 51 onto the fork sleeves. The axle is rotatable, but can be of limited rotation, so that the tire curve hangs horizontally when lifted by the truck.

FIG. 10a shows how the tire basket is used. The basket is placed on the forks so that it stands on the side of the truck, i.e. between the truck and the tire rack. The tires are tilted onto the basket 42 whereby the truck is driven out from the rack with the tires. At the destination, the truck putts down the trolley so that the support wheels 47 are pressed against the floor and the trolley rotates around the boom arm until the tire trolley basket is in vertical position. The trolley with tires is then released from the basket/truck and can be rolled away.

The purpose of this construction is to avoid lifting and manual handling of the tires as much as possible. In some cases, it may be desirable to use a solution where the truck is placed directly behind the tire basket to save space. In this case, the protruding part is loosened, and the fork sleeves are rotatable attached to the end of the basket.

1-9. (canceled)

10. A storage system including a displaceable storage rack, the storage system comprising
first and second floor-mountable rails;
a base frame comprising:
first and second rectangular supporting elements alignable on and parallel to corresponding rails, each of the supporting elements having a first end and a second end, wherein each supporting element comprises wheels having guide flanges and a rotatable locking hook at the first end of the supporting element and a corresponding locking lug at the second end of the supporting element, wherein the locking hooks are connected to a rod so that the locking hooks can be rotated together, and wherein each locking hook comprises a tapered leading end adapted to climb onto a corresponding locking lug of another supporting element such that a number of supporting elements may be locked together and moved as one unit; and
a plurality of coupling members connecting the supporting elements;
a rack mountable on the supporting elements; and
a drive unit to displace the supporting elements and the rack along the rails, wherein the drive unit comprises a floor-mountable linear drive unit connectable to the base frame.

11. A storage system according to claim 10, wherein the first and second rectangular supporting elements each comprises a hollow profile and least two wheels mounted within the hollow profile, wherein each wheel protrudes through an opening in the hollow profile.

12. A storage system according to claim 11, wherein each of the first and second rectangular supporting elements comprises a plurality of coupling pieces projecting horizontally from the supporting element and the coupling members comprises hollow tubes which are threaded onto the coupling pieces and attached thereto.

13. A storage system according to claim 11, wherein each of the first and second rectangular supporting elements comprises a plurality of holes on an upper side for fastening the rack, wherein the holes comprise threads, in which each thread is provided with a threaded mounting bush suitable for receiving hollow wall tubes in the rack, the wall tubes being attached to the mounting bushes.

14. A storage system according to claim 13, further comprising locking nuts which lock the mounting bushes to the supporting elements.

15. A storage system according to claim 14, wherein each support frame comprises four coupling members and each support frame is arranged to carry two rows of car tires.

16. A storage system of claim 11, wherein each support frame comprises four coupling members and each support frame is arranged to carry two rows of car tires.

17. A storage system of claim 11, wherein a pallet rack is attached to the coupling members.

18. A storage system of claim 10, wherein the rails comprise flat sections lying on the floor and attached thereto.

19. A storage system of claim 10, wherein the drive unit comprises a pneumatic cylinder, a hydraulic cylinder, or an electric linear motor, which is controlled by a remote control or joystick.

20. A frame for use in a storage system, the frame comprising
first and second rectangular supporting elements alignable on and parallel to corresponding rails,
a plurality of wheels having guide flanges disposed within the first and second rectangular supporting elements;
a first locking hook at a first end of the first supporting element and a first locking lug at a second end of the first supporting element, wherein the first locking hook comprises a tapered leading end adapted to climb onto a corresponding locking lug of another supporting element such that a number of supporting elements may be locked together and moved as one unit;
a second locking hook at a first end of the second supporting element and a second locking lug at a second end of the second supporting element, wherein the first locking hook comprises a tapered leading end adapted to climb onto a corresponding locking lug of another supporting element such that a number of supporting elements may be locked together and moved as one unit;
a rod connecting the first and second locking hooks so that the locking hooks can be rotated together; and
a plurality of coupling members connecting the first and second supporting elements.

21. A frame according to claim 20, wherein the first and second rectangular supporting elements each comprise a hollow profile and least two wheels mounted within the hollow profile, wherein each wheel protrudes through an opening in the hollow profile.

22. A frame according to claim 21, wherein each of the first and second rectangular supporting elements comprises a plurality of coupling pieces projecting horizontally from the supporting element.

23. A frame according to claim 21, wherein each of the first and second rectangular supporting elements comprises a plurality of holes on an upper side for fastening a rack, wherein the holes comprise threads, in which each thread is provided with a threaded mounting bush suitable for receiving hollow wall tubes in the rack, the wall tubes being attached to the mounting bushes.

24. A frame according to claim 23, further comprising locking nuts which lock the mounting bushes to the supporting elements.
